(19) United States
(12) Patent Application Publication
(10) Pub. No.: US 2026/0098674 A1
(43) Pub. Date: Apr. 9, 2026

(54) DEVICES FOR ETCHING CLEAR ICE PRODUCTS

(71) Applicant: Abstract Ice, Inc., Petaluma, CA (US)

(72) Inventors: Todd Stevenson, Novato, CA (US); Andrew James Whalen, Windsor, CA (US); Larry Allen Mercier, JR., Ann Arbor, MI (US); James Anthony Coller, Ann Arbor, MI (US)

(21) Appl. No.: 19/351,612

(22) Filed: Oct. 7, 2025

Related U.S. Application Data
(60) Provisional application No. 63/705,003, filed on Oct. 8, 2024.
(60) Provisional application No. 63/774,879, filed on Mar. 20, 2025.

(51) Int. Cl. F25C 5/14; B28D 1/18; G05B 19/418

(52) U.S. Cl. CPC F25C 5/14; B28D 1/186; G05B 19/41815; G05B 2219/33099; G05B 2219/45212

(57) ABSTRACT

A device may include an ice etching system comprising: a multi-spindle assembly comprising: a plurality of spindles arranged in parallel and movable according to at least two coordinates, wherein each spindle is coupled to at least one cutting tool; and a spindle guidance system in electrical communication with at least one controller and the plurality of spindles, the spindle guidance system being adapted to receive instructions comprising a pattern and a configuration for the at least one cutting tool, and use the instructions to control each spindle in the multi-spindle assembly to generate, according to the pattern, one or more cutting path or one or more etching path on a portion of each of a plurality of ice ingots arranged substantially adjacent to the plurality of spindles.

### CROSS-REFERENCE TO RELATED APPLICATION

This application claims the priority benefit of U.S. Provisional Application No. 63/774,879, filed on Mar. 20, 2025, and the priority benefit of U.S. Provisional Application No. 63/705,003, filed on Oct. 8, 2024, the disclosures of which are herein incorporated by reference in their entireties.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of ice manufacturing, and more specifically to the field of clear ice manufacturing. Described herein are devices and methods for etching clear ice.

### BACKGROUND

Generating ice that may robust enough to be further handled before being sold for consumption can be a difficult task. To enhance the overall user experience of ice, many restaurants and bars add garnishes and/or specialty ice to cocktails. Currently, these restaurants and bars purchase large blocks of ice that are then cut down in-house to the appropriate size for each drink. Issues with standard ice generation machines and in-house cutting of such ice may lead to cracking, trapped air bubbles, and water impurities resulting in ice that lacks the desired appeal and appearance.

### SUMMARY

There is a need for new and useful device and method for etching patterns into clear ice. In addition, there is a need for increased throughput of generating etched, clear ice.

In some aspects, the techniques described herein relate to an ice etching system including: a multi-spindle assembly including: a plurality of spindles arranged in parallel and movable according to at least two coordinates, wherein each spindle is coupled to at least one cutting tool; and a spindle guidance system in electrical communication with at least one controller and the plurality of spindles, the spindle guidance system being adapted to receive instructions including a pattern and a configuration for the at least one cutting tool, and use the instructions to control each spindle in the multi-spindle assembly to generate, according to the pattern, one or more cutting path or one or more etching path on a portion of each of a plurality of ice ingots arranged substantially in parallel.

In some aspects, the techniques described herein relate to an ice etching system, wherein each of the plurality of spindles is adapted to automatically exchange cutting tools from a first tool set to a second tool set, according to the instructions, and wherein each of the plurality of spindles includes: a tool holder for receiving the at least one cutting tool, the tool holder including pneumatic, automated controls for clamping and unclamping of the at least one cutting tool when receiving a command according to the instructions, to exchange the first tool set with the second tool set.

In some aspects, the techniques described herein relate to an ice etching system, wherein each of the plurality of spindles are secured by a bracket that couples to a gantry of the ice etching system through a framing member, each bracket being coupled to the framing member in substantially equal intervals along a length of the framing member.

In some aspects, the techniques described herein relate to an ice etching system, wherein: the ice etching system is a computer numerical control (CNC) machine mounted to a table frame and the gantry; and each of the plurality of spindles is coupled to at least one rotating shaft in electrical communication with the gantry.

In some aspects, the techniques described herein relate to an ice etching system, wherein the ice etching system further includes an interchangeable tray system for providing the plurality of ice ingots on a table frame in a configuration for receiving, according to the instructions, the one or more cutting path or the one or more etching path in a respective of the plurality of ice ingots.

In some aspects, the techniques described herein relate to an ice etching system, wherein the table frame includes a plurality of pairs of flexure bars configured to contact each ice ingot on a first sidewall and a second sidewall and in various locations along a length of each ice ingot in the plurality of ice ingots.

In some aspects, the techniques described herein relate to an ice etching system, wherein the plurality of pairs of flexure bars include clamps to secure the at least one ice ingot laterally during a cutting process or an etching process.

In some aspects, the techniques described herein relate to an ice etching system, wherein the cutting process slices from a top surface to a bottom surface of one or more of the plurality of ice ingots according to the instructions.

In some aspects, the techniques described herein relate to an ice etching system, wherein the etching process defines partial cuts or indentations in a surface portion of one or more of the plurality of ice ingots.

In some aspects, the techniques described herein relate to an ice etching system, wherein the plurality of ice ingots represent a plurality of slabs of ice.

In some aspects, the techniques described herein relate to an ice etching system, wherein each of the plurality of ice ingots include an elongate ice ingot having about 0.8 meters to about 2.0 meters in length.

In some aspects, the techniques described herein relate to an ice etching system, wherein the plurality of spindles are each coupled to the at least one tool to substantially simultaneously, according to the instructions, etch the pattern into the plurality of ice ingots.

In some aspects, the techniques described herein relate to an ice etching system, further including a vacuum system including a vacuum configured to remove ice chips and water from an etching field occurring around each of the at least one tool during an etching process.

In some aspects, the techniques described herein relate to an ice etching system, wherein the vacuum system further includes at least one air nozzle communicatively coupled to the vacuum and mounted to blow air across the etching field and toward the vacuum.

In some aspects, the techniques described herein relate to an ice etching system, wherein each of the plurality of ice ingots are elongated in shape and are arranged in parallel to one another and substantially perpendicular to the plurality of spindles.

In some aspects, the techniques described herein relate to an ice etching system, further including: a software interface in communication with the at least one controller, the software interface including a tool selection control, a spindle warmup control, a tool unloading control, and a tool loading control.

In some aspects, the techniques described herein relate to an ice etching system, wherein the ice etching system further includes: an ice cutting system including at least one saw assembly configured to perform a plurality of cuts to shear the at least one ice ingot into multiple ice structures during or after an etching process, the cuts being predetermined to occur between etched portions of the at least one ice ingot; an outfeed assembly spaced between a distal end of the ice etching system and a proximal end of the ice cutting system, wherein the outfeed assembly includes a drive means to guide movement of the at least one ice ingot from the ice etching system to the ice cutting system and to pass the at least one ice ingot through the at least one saw assembly.

In some aspects, the techniques described herein relate to a method for manufacturing craft ice including: providing a device for etching ice including: a table frame; and a multi-spindle assembly including: a plurality of spindles arranged in parallel and movable according to at least two coordinates, wherein each spindle is coupled to at least one cutting tool; and a spindle guidance system in electrical communication with at least one controller and the plurality of spindles, the at least one controller being configured to receive and execute instructions including: detecting a plurality of ice ingots arranged in a sequence at a holder, the holder being at least partially coupled to the table frame; receiving a pattern and a configuration for directing the plurality of spindles in the multi-spindle assembly to generate, according to the pattern, one or more etching paths on a portion of the plurality of ice ingots; and responsive to the detecting, causing the plurality of spindles to generate, according to the pattern, the one or more etching paths on the portion of the plurality of ice ingots.

In some aspects, the techniques described herein relate to a method, wherein the instructions further include: causing advancement of the plurality of spindles in tandem, each respective spindle being advanced to a second portion of each of the plurality of ice ingots, the second portion being adjacent to the portion; causing the plurality of spindles to generate, according to the pattern, additional etching paths, that substantially match the one or more etching paths, on the second portion of each of the plurality of ice ingots; and causing the plurality of spindles to repeat the pattern of the one or more etching paths on subsequently adjacent portions of the plurality of ice ingots until reaching a distal end of a length of at least one of the plurality of ice ingots.

In some aspects, the techniques described herein relate to a method, wherein causing the plurality of spindles to generate, according to the pattern, the one or more etching paths includes: causing the plurality of spindles to generate, according to the pattern, the one or more etching paths on the portion of a first of every other ice ingot in the sequence.

In some aspects, the techniques described herein relate to a method, wherein the instructions further include: causing advancement of the plurality of spindles in tandem, to a second portion of the first of every other ice ingot in the sequence, the second portion being adjacent to the portion; causing the plurality of spindles to generate, according to the pattern, additional etching paths, that substantially match the one or more etching paths, on the second portion of the first of every other ice ingot in the sequence; and causing the plurality of spindles to repeat the pattern of the one or more etching paths on subsequently adjacent portions of the first of every other ice ingot in the sequence until reaching a distal end of a length of the first of every other ice ingot in the sequence.

In some aspects, the techniques described herein relate to a method, wherein the instructions further include: upon reaching the distal end of the length, returning to a proximal end of the length of the plurality of ice ingots and causing the plurality of spindles to generate, according to the pattern, the one or more etching paths on a first portion of a second of every other ice ingot in the sequence.

In some aspects, the techniques described herein relate to a method, wherein the instructions further include: causing advancement of the plurality of spindles in tandem, to a second portion of the second of every other ice ingot in the sequence, the second portion being adjacent to the first portion; causing the plurality of spindles to generate, according to the pattern, additional etching paths, that substantially match the one or more etching paths, on the second portion of the second of every other ice ingot in the sequence; and causing the plurality of spindles to repeat the pattern of the one or more etching paths until reaching a distal end of a length of the second of every other ice ingot in the sequence.

In some aspects, the techniques described herein relate to a method, wherein the instructions further include: receiving a recipe program defining at least one etching step and at least one post processing step; and executing the recipe program to cause the device to generate the pattern in the plurality of ice ingots according to the recipe program.

The details of one or more implementations are set forth in the accompanying drawings and the description below. Other features will be apparent from the description and drawings, and from the claims.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1A illustrates a perspective view of an example ice etching system having a single etching spindle.

FIG. 1B illustrates a perspective view of an example ice etching system after beginning an ice etching process.

FIG. 2A illustrates a side view of an ice etching system having a multi-spindle assembly.

FIG. 2B illustrates an example perspective view of the ice etching system of FIG. 2A.

FIG. 2C illustrates an example end view of the ice etching system of FIG. 2A.

FIG. 2D illustrates a top down view of the ice etching system of FIG. 2A.

FIG. 2E illustrates a perspective view of an example multi-spindle assembly for use with the devices described herein.

FIG. 2F illustrates a perspective partial view of the multi-spindle assembly of FIG. 2E.

FIG. 2G illustrates a perspective view of a bracket for coupling a spindle to the multi-spindle assemblies described herein.

FIG. 3A illustrates a perspective view of an ice ingot for use with the systems described herein.

FIG. 3B illustrates a perspective view of an example of a plurality of ice ingots on a tray for use with the systems described herein.

FIG. 3C illustrates a zoomed in partial view of the ice etching system of FIG. 2A showing etched ice ingots.

FIG. 4A illustrates a perspective partial view of an example tray for holding a plurality of ice ingots in an example implementation of the ice etching system of FIG. 2A.

FIG. 4B illustrates an example of a gantry coupled to a plurality of spindles in an example implementation of the ice etching system of FIG. 2A.

FIG. 4C illustrates an etched block of ice.

FIG. 5 illustrates a block diagram of an example ice etching system.

FIG. 6 illustrates a flow diagram of an example process for etching ice.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the claimed subject matter. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

The present disclosure describes devices, systems, and methods for producing clear ice. For example, the devices, systems and methods described herein may produce (e.g., manufacture, modify, generate, package, etch, cut, design, etc.) clear ice of a variety of shapes and sizes. In some embodiments, the clear ice may be produced by cutting or etching portions of the ice ingots. For example, the devices, systems, and methods described herein may etch, cut, scratch, and/or plane along one or more surfaces, edges, or corners of clear ice ingots. In some embodiments, the systems and methods described herein may etch the ice ingot to prepare the ice ingot for additional processing before being cut into a variety of shapes that are ready for sale and/or use.

In general, etching an ice ingot may include an etching process that defines locations, depths, patterns, or other input for making partial cuts, scratches, etchings, marks, or indentations in a surface portion (or portion beneath the surface portion) of one or more ice ingots. In some embodiments, the devices, systems, and methods described herein function to etch and prepare ice ingots for cutting the ingots into a number of different shapes and sizes. An example preparation may include strategically cutting portions (e.g., one or more surfaces or edges) of the ice ingot using a cutting assembly, etching assembly or a combination thereof that utilizes tools such as blades, picks, knives, and/or any number of similar or different saws (e.g., bandsaws, circular saws, etc.), etc. to produce a manufactured clear ice product having etched portions. The etched portions may be decorative or utilitarian, or both. For example, a number of etched portions may indicate a decorative or advertisement based pattern while another one or more etched portions along an ice ingot may be indicators for where future cutting or dividing of ice may occur. One of skill in the art will appreciate how these devices and methods can be adapted to such different combinations of tools for use in simultaneously etching and/or cutting any number of ice ingots.

In some embodiments, the devices described herein may include an ice etching system that utilizes a computer numerical control (CNC) machine to etch patterns into multiple elongate ice ingots simultaneously. In some embodiments, the ice etching system may include a table frame, a multi-spindle assembly, and various supporting components to enable etching and/or cutting of ice portions resulting in a pattern being manufactured into (or onto) one or more surfaces, edges, or corners of the ice ingot. The pattern may be repeated along a length of the ice ingot, for example, to generate a number of ice portions that may be cut to size to reveal singular use ice structures having patterns etched therein. The patterns may be predetermined and/or preprogrammed and may be etched into the ice ingot surface(s), edges, or corners by a number of tools operating substantially simultaneously across a row of ice ingots, for example. The tools may be installed in spindles communicatively coupled to one or more controllers, motors, guides, gantries, and/or controls, of the ice etching system.

In some embodiments, the ice etching systems described herein may include a table frame, a multi-spindle assembly, etching/cutting tools, a control system, and/or a vacuum system that function together to etch patterns onto one or more surfaces of multiple ingots of ice. In some embodiments, the ice etching systems may simultaneously perform etching of multiple ingots of ice arranged substantially in parallel along a table frame. For example, the multiple ingots of ice may be simultaneously etched from a proximal end to a distal end (e.g., along the longitudinal lengths) of the multiple ice ingots. The etching may result in generating a pattern on at least one surface (and/or through to multiple surfaces below the at least one surface) of each of the multiple ice ingots and may iteratively move across the length of each of the multiple ice ingots generating the same pattern next to a previous pattern in each respective ice ingot. For example, multiple etching tools may function in tandem on any number of ice ingots. In some embodiments, a number of etching tools may be mounted substantially in parallel where each etching tool may etch across or into a surface of each of any number of ice ingots arranged, substantially in parallel to one another. Each tool may be arranged to etch into one of the number of other ice ingots at substantially the same time the other etching tools (e.g., in separate spindles) are etching one or more (or all) of the other ice ingots.

In some embodiments, the ice etching systems may simultaneously perform etching on a first set of multiple ingots of ice and may subsequently perform an etching on a second set of multiple ingots of ice. The first set of ingots and the second set of ingots may be arranged in a side-by-side fashion, and substantially parallel to one another. In some embodiments, the first set of ingots may be arranged in an every-other-ingot arrangement while respective ingots from the second set may be arranged between the ingots of the first set. In this example, the first set may be etched from a proximal end to a distal end of a length of the first set of ice ingots. The second set may then be etched in a simultaneous fashion after completion of the etching of the first set of ice ingots. In such an example, the ice etching system may include a number of spindles (e.g., for receiving tools for etching) that matches one half of the arranged ice ingots. The etching in this example is performed in a first pass from the proximal to distal ends of the first set of ice ingots and a second pass from the proximal to distal ends of the second set of ice ingots (or in reverse from the distal to the proximal ends). In some embodiments, the number of spindles may vary to match or exceed a number of ice ingots being arranged for etching. In some embodiments, the number of spindles may vary to be fewer than a number of ice ingots being arranged for etching, as described above in the example in which the etching occurs in a first pass and a second pass. Any number of passes may be performed to etch a set of ice ingots. A number of spindles installed on the etching systems described herein may include 1 to 40 spindles; 2 to 10 spindles; 10 to 20 spindles; 20 to 30 spindles; or 30 to 40 spindles. A number of tools may be installable in each spindle. For example, each spindle may be adapted to receive 1 to 20 tools; 1 to 5 tools; 5 to 10 tools; 10 to 15 tools; or 15 to 20 tools. Tools may be installed in combination and function together or may instead be singularly installed to be interchangeable within a spindle. Interchanging tools in spindles may be performed in an automated fashion, as described elsewhere herein.

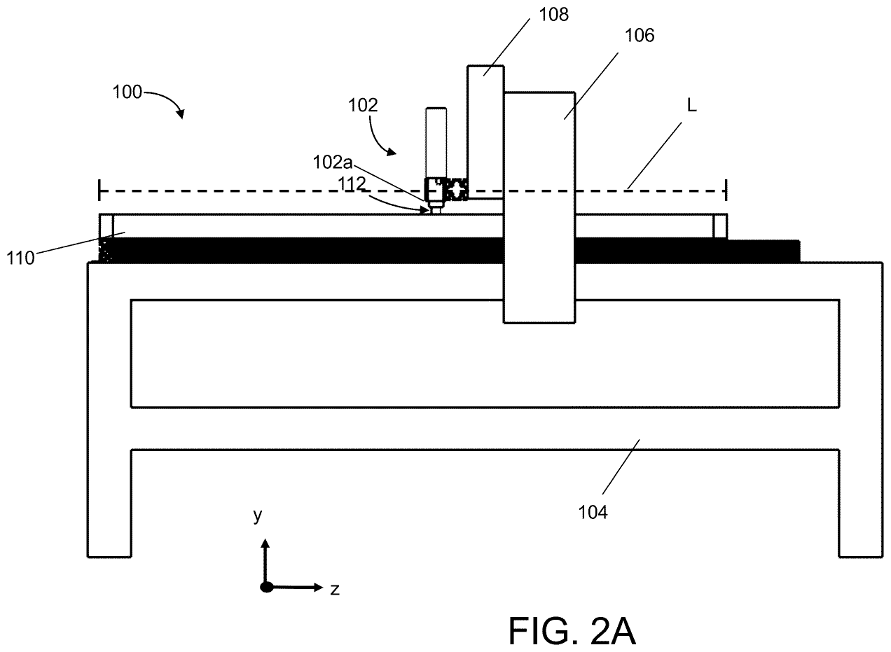

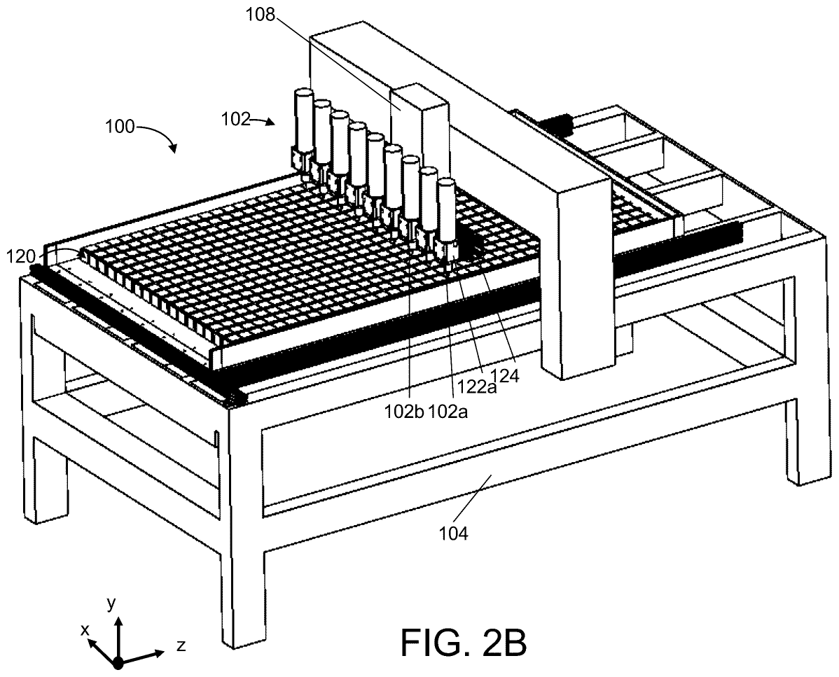

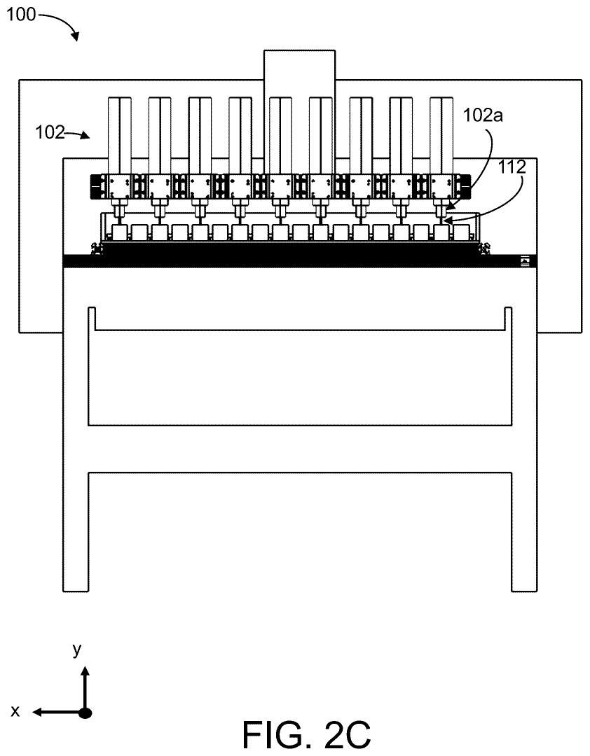

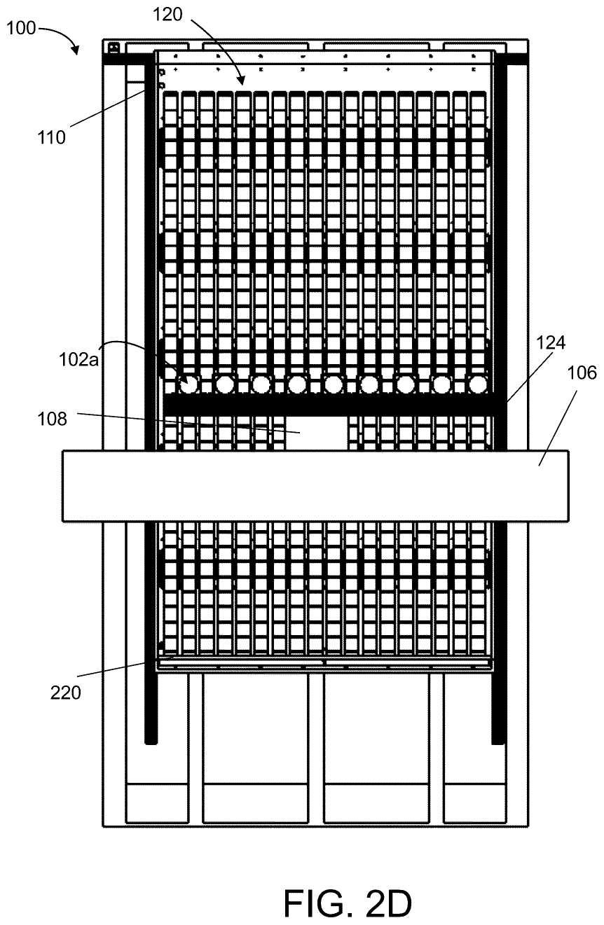

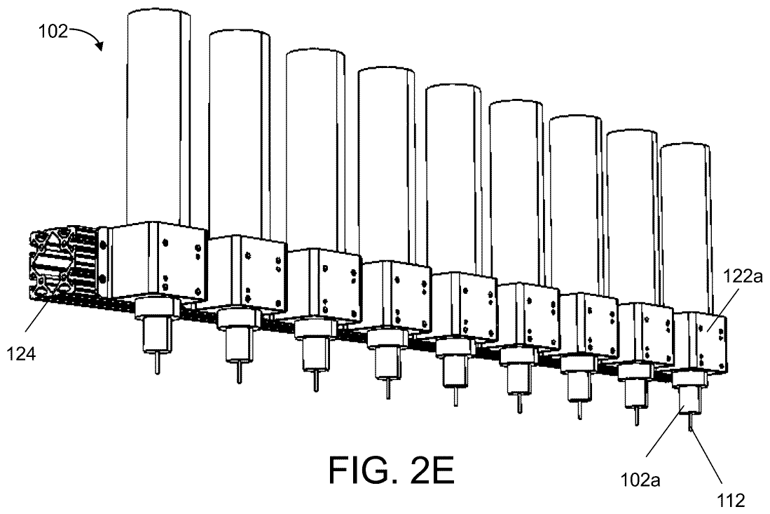

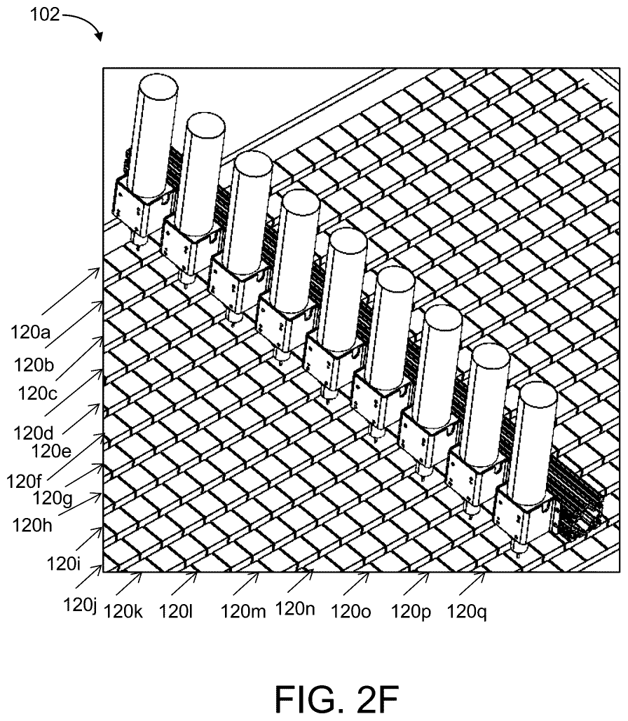

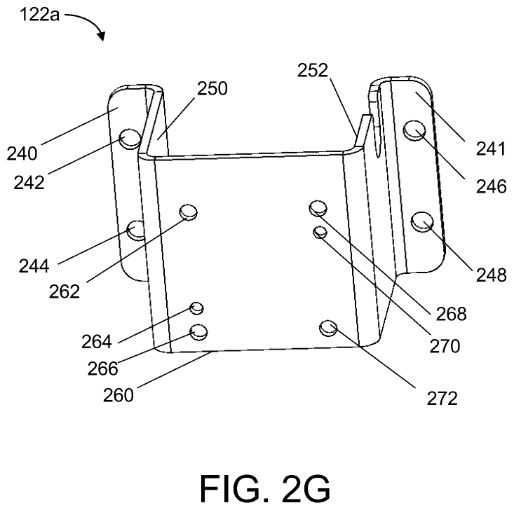

The resulting output of completing the etching may include a generated/etched/cut pattern in at least one surface of each of the ice ingots and a repeat of this pattern across the at least one surface according to a recipe and/or instructions. For example, the pattern may be etched in a first location of the surface and the device may iteratively move to a second location, third location, fourth location, etc. on the surface over the length of the ice ingots, resulting in generation of the same pattern next to a previous pattern, and so on, over the length (e.g., L in FIG. 2A) of each respective ice ingot (e.g., ice ingot 120 in FIG. 2B). Upon completion of the etching, the ingots may be divided (e.g., cut) between the patterned etchings to generate individual blocks (pieces) of ice, each having the etched pattern. In some embodiments, the ice etching systems described herein may include a cutting tool or mechanism to divide the ice ingots into individual blocks. In some embodiments, the ice etching systems described herein may be coupled to a conveyer or other mechanism to move the etched ice into a second cutting apparatus.

The devices described herein solve a technical problem of generating precisely etched ice in an efficient manner using a machining process that may utilize single or multi-spindle assemblies. This precision allows for achieving detailed and accurate etching on multiple elongate ice ingots in a reduced amount of time over conventional systems. For example, the devices described herein may handle and etch multiple ice ingots substantially simultaneously, which may increase efficiency and throughput of generating etched ice, as compared to conventional systems. These benefits collectively address the need for a more efficient, precise, and consistent ice etching process that may be performed in a decreased amount of time over conventional systems to retain ice temperature and ensure resulting in high quality etched ice.

The devices described herein may further include a tool changer. The tool changer may select and replace tools in one or more spindles. Changing tools may be performed in an automated fashion to improve etching time and to reduce or eliminate manual intervention and errors in the etching process.

In some embodiments, the devices, systems, and methods described herein may etch ice ingots on one or more surfaces of each ice ingot. In general, the ice ingots that are etched by the devices, systems, and methods described herein are elongate ingots of ice generated by an ice making machine. The elongate ice ingots may be fed into and/or otherwise received by the devices described herein in a partially or completely clear, crystalline form. In some embodiments, the systems described herein may perform the described etching on blocks, chips, cubes, or other shaped ice. For example, ice may be precut before being etched in some examples described herein.

In some embodiments, the ice ingots have a bottom surface, a first side surface, a second side surface, and a top surface and measure about 2.5 centimeters to about 10 centimeters in height on a side. In some embodiments, the ingots are cylindrical or semi-cylindrical and may have a radius of about 2 centimeters to about 10 centimeters. In some embodiments, the ice ingots are shorter in height than in width. In some embodiments, the ice ingots are taller in height than in width. In some embodiments, the ice ingots used in the devices described herein are slabs of ice. The slabs may have a height of about 5.1 centimeters (e.g., 1.5 inches) to about 10 centimeters (e.g., 4 inches); about 5.1 centimeters (e.g., 1.5 inches) to about 10 centimeters (e.g., 2 inches); about 5 centimeters (e.g., 2 inches) to about 7.6 centimeters (e.g., 3 inches); about 7.6 centimeters (e.g., 3 inches) to about 8.9 centimeters (e.g., 3.5 inches); or about 8.9 centimeters (e.g., 3.5 inches) to about 10 centimeters (e.g., 4 inches). In some embodiments, the ice ingots cut by the devices described herein may measure about one meter to about four meters in length. However, other shapes and sizes are contemplated including, but not limited to ice blocks, ice chips, ice cubes, or other shaped ice.

Because ice can be melted into water during processing, the components of the systems described herein are generally made of waterproof or water wicking materials. Components that are not waterproof may be protected by shrouds, coatings, and/or within waterproof casings that partially or wholly cover such components. Because the ice is for human consumption, food contact and non-food contact components are generally food-safe, such as stainless steel or anodized aluminum.

As used herein, the terms “etch” and/or “etching” may include shaping, embossing, shaving, melting, or any other subtractive manufacturing approach of producing ice having a desired shape, form, or appearance that includes a layer-by-layer/multi-layer removal of material from an ice solid without cutting or moving from a first external surface of an ice ingot to a second external surface of the ice ingot.

As used herein, the terms “cutting” and/or “cut” may include planing, shearing, trimming, sawing, or any other subtractive manufacturing approach of producing ice having a desired shape, form, or appearance and that includes a layer-by-layer/multi-layer removal of material from an ice solid from a first external surface of an ice ingot through to a second external surface of the ice ingot.

As used herein, the term “conveyor” may include conveyor belts and may additionally include cleats coupled to conveyor belts for added control of ice ingots. Such conveyors may be positioned as infeed or outfeed assemblies of the ice planning systems described herein.

The devices described herein may utilize multiple custom buttons, tool changing with tool number selection, spindle warmup algorithms, tool unloading algorithms, and the like. In some embodiments, such tool selections, tool loading/unloading algorithms, and/or spindle warmup algorithms may be programmed in software to allow the hardware of the ice etching devices described herein to operate.

In some embodiments, a tool changer system may be provided to interface with the ice etching systems described herein. The tool changer system may include one to thirty spindles, for example, and each spindle may be equipped with integrated automatic tool changing (ATC) capabilities. The systems described herein may employ tool holders designed to accommodate a variety of tools for all spindles. Each ATC unit may incorporate pneumatic actuation mechanisms that control the tool clamping and unclamping operations. The systems described herein may operate through g-code programming protocols, which facilitate automated tool selection and exchange procedures.

In one non-limiting example, an ice etching system may include nine spindles, each including any number of tools that may be interchanged onto tool holders corresponding to each spindle. In this example, the ice etching system may accommodate up to eighteen ice ingots, each measuring 80 inches in length. The ice ingots may be provided to the ice etching system raw from a mold or may have undergone preliminary processing to achieve planar surfaces on the top, bottom, and lateral faces, while maintaining unprocessed end surfaces. The ingots may be automatically (e.g., machine placed) or manually positioned within designated holders on an etching bed having dimensions of about four feet to about feet. The bed may incorporate precision-engineered guide elements, terminal stops, and centralization mechanisms to ensure precise positional accuracy of the ingots, as described elsewhere herein. Each spindle operating specification may encompass rotational velocities ranging from about 10,000 revolutions per minute (RPM) to about 24,000 RPM, with linear feed rates varying between about 30 and about 100 inches per minute. The cutting tools may include single and double flute down cut flat end mill bits, featuring cutting lengths ranging from about 0.1 centimeters (e.g., about 0.04 inches) to about 1.3 centimeters (e.g., about 0.5 inches). The tools may include features to remove material at a particular rate and/or to allow a particular surface finish quality on the ice ingots.

In some embodiments, computer aided manufacturing (CAM) software may be used with customized algorithms to execute tool changing, spindle start/stop processes, pre-processing of ice, post-processing of ice, or the like. For example, the operational interface for the ice etching system may utilize CAM software for generating g-code instructions that define the etching patterns. The control system of the ice etching system may interpret the g-code commands to orchestrate the synchronized three-dimensional movement and rotational speed control of nine spindles, enabling simultaneous pattern replication across nine ingots using end mill cutting tools. The g-code architecture permits unique pattern programming for each set of nine ingots processed. Upon completion of the etching sequence, the processed ingots may be automatically or manually extracted (or a combination thereof). Processed ingots may be extracted to shipping packaging or subsequent segmentation operations.

### Systems and Devices

Disclosed herein are devices and methods for etching clear ice. In particular, the disclosure herein provides for devices and methods allowing for the expedited production of etched ice having an improved quality over conventional apparatuses and methods. In some embodiments, the devices and methods disclosed herein are adapted for etching on ice made from frozen water; however, one of skill in the art will appreciate how these devices and methods can be adapted to allow for the etching on other frozen liquids (e.g., ethanol, food-based liquids, etc.). In some embodiments, the term “water” will be frequently used also; however, this use of the term “water” should not be considered limiting for the reasons stated herein. For similar reasons, the use of the term “ice” to refer to the chosen liquid when frozen should also not be considered limiting.

In general, the devices described herein function to produce clear, etched elongate ice ingots or clear, etched ice blocks. The devices and/or assemblies described herein may etch clear ice according to user input, recipe input, automated input, or any combination of the thereof.

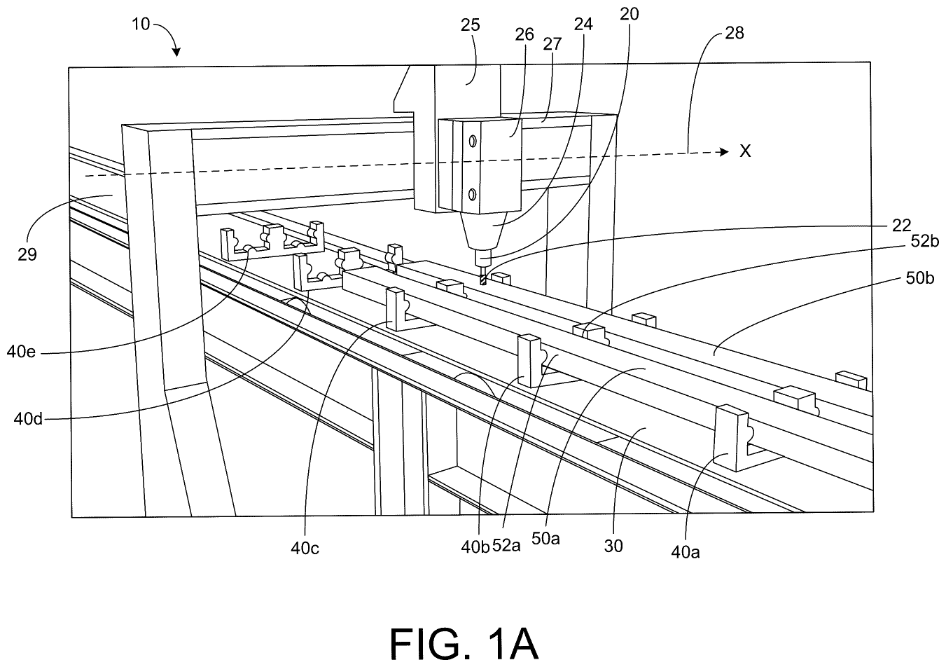

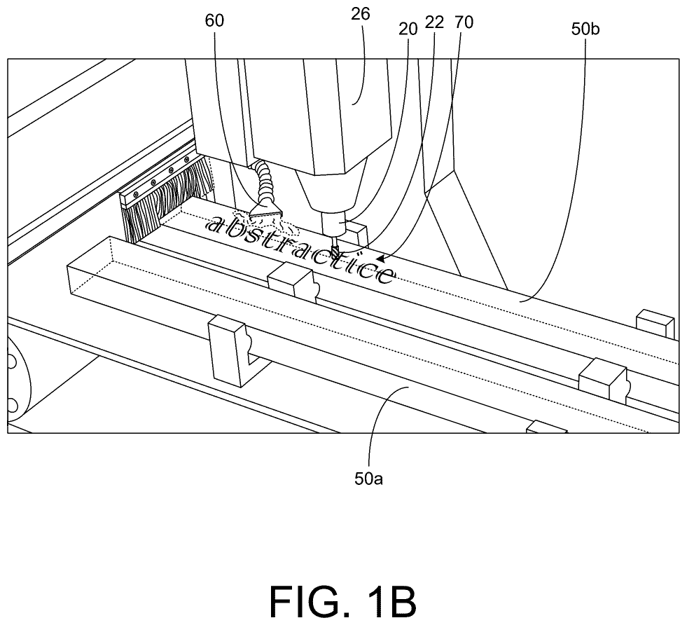

FIG. 1A illustrates a perspective view of an example ice etching device 10 having a single etching spindle 20. The spindle 20 may be secured to a tool 22 and a housing 24. The tool 22 may include any number of tools for etching or cutting ice. The tool 22 may be exchangeable with any number of other tools for etching or cutting ice. The spindle 20 may be secured to a housing 24, which may be coupled to a gantry 25. The gantry 25 may be moveably coupled to a fixed support member 27 to allow the gantry to move along an x-axis 28 to align etching operations. The housing 24 may include one or more motors (not shown), motor controls/pneumatic controls (not shown), one or more processors (not shown), or other motion or control components for performing etching or moving ice ingots to receive etching.

The spindle 20 may allow for automated tool exchanges, as described elsewhere herein. The spindle 20 may include pneumatic controls (not shown) for tool clamping and unclamping. A shroud 26 may include a motor assembly (not shown) with any number of rotors, windings, and/or processors for controlling spindle 20 and system 10. The spindle 20 may be communicatively coupled to a spindle control or other latching mechanism to swap between tools or tool sets.

The ice etching device 10 may include a table frame 30 having a number of flexure bars 40a, 40b, 40c, 40d, 40e, etc. that may flex to support and/or secure one or more ice ingots, such as ice ingot 50a and ice ingot 50b, to a portion of the table frame 30. For example, the flexure bars 40a-40e, etc. may secure ice ingots 50a, 50b to align the ingots in a substantially parallel arrangement for receiving etching patterns on one or more surfaces of the ingots and from one or more spindles 20 as the spindle moves along fixed support member 27 and/or as a conveyor (e.g., conveyor 29) moves ice ingots 50a, 50b toward the tool 22, for example. The flexure bars 40a-40e may be arranged to contact a first sidewall 52a and a second sidewall 52b on ice ingot 50a. Similarly, at least two sidewalls of ingot 50b may be arranged to contact portions of flexure bars 40a-40e. The flexure bars 40a-40e may be positioned at various locations along the ice ingot length to stabilize the ice ingot during an etching process. In some embodiments, the flexure bars 40a-40e may further include one or more clamps to secure ingots laterally along the table frame 30 during the etching process. The flexure bars 40a-40e may be formed of food safe materials as described elsewhere herein. The flexure bars 40a-40e may actively or passively restrain the ice ingots. In some embodiments, the flexure bars described herein may function to passively center the ice ingots to allow etched patterns to be automatically centered on the ingots regardless of the ingot width.

FIG. 1B illustrates a perspective view of the example ice etching device 10 after beginning an ice etching process. In this example, the device 10 includes a vacuum system 60 for removing water and ice chips during etching. In some examples, the vacuum system 60 may include at least one air nozzle (not shown) mounted to blow air across the etching field and toward the vacuum 60.

In operation, the spindle 20 may be programmed to engage in a process to etch a pattern 70 onto a portion of the ice ingot 50b using the tool 22 that operates according to instructions received from a processor that stores a CNC control system program, a recipe program, instructions, or other input for etching ice ingots.

FIG. 2A illustrates a side view of an ice etching system 100 having a multi-spindle assembly 102. The multi-spindle assembly 102 may etch ice ingots according to a predefined pattern or recipe. The multi-spindle assembly 102 may utilize a CNC router configuration with a table frame 104, a support 106, and a gantry 108 (e.g., similar to gantry 25 and/or gantry 450). The gantry 108 may allow movement along the z-axis (i.e., function as a z-motion component) and may receive instructions from a controller programmed to etch the ice ingots held by a tray 110 (e.g., a deck, one or more ice holders, and/or an ice retaining system, or the like).

The single spindle assembly of FIGS. 1A-1B may be replaced with the multi-spindle assembly 102, where each spindle within spindle assembly 102 has automatic tool-changing capabilities. This tool change may allow for performing rough cuts, fine details cuts, or other etching indents, cuts, or shaped hollow portions with the same assembly 102. The tool change may be performed by a tool exchanger system 515. Tool exchange may be automated such that etching time is improved for each etching cycle.

In some embodiments, the multi-spindle assembly 102 includes a plurality of spindles arranged substantially in parallel and movable according to at least two coordinates (e.g., x-axis and y-axis movement). A third coordinate may also be available through controls that instruct the gantry 108 and/or through use of movement of ice ingots on the tray 110 along the z-axis. Each spindle may be coupled to at least one cutting tool 112 (e.g., etching, cutting, mitering, etc.). The gantry 108 may include a spindle guidance system that is in electrical communication with at least one controller and the plurality of spindles (e.g., spindle 102a, 102b, etc.). The spindle guidance system may be adapted to receive instructions that include one or more patterns and a configuration for the at least one cutting tool 112. The spindle guidance system may use the instructions to control each spindle in the multi-spindle assembly 102 to generate, according to the one or more patterns, one or more cutting paths and/or one or more etching paths on a portion of each of any number of ice ingots on the tray 110.

The tray 110 may be an interchangeable tray system allowing for different ingots of ice to be placed on the table frame 104. The table frame 104 may have a width of about 0.5 meters (about 1.6 feet) to about 1.5 meters (about 5 feet); about 0.5 meters (about 1.6 feet) to about 1 meter (3 feet); about 1 meter (about 3 feet) to about 1.2 meters (about 4 feet); about 1.2 meters (about 4 feet) to about 1.5 meters (about 5 feet); or about 1.5 meters (about 5 feet) to about 2 meters (about 6.6 feet).

The table frame 104 may have a length of about 1.2 meters (about 4 feet) to about 4 meters (about 13 feet); about 1.2 meters to about 1.5 meters (about 5 feet); about 1.5 meters (about 5 feet) to about 2 meters (about 6.6 feet); about 2 meters (about 6.6 feet) to about 3 meters (about 9.8 feet); or about 3 meters (about 9.8 feet) to about 4 meters (about 13 feet). The support structure of table frame 104 may be formed of 80/20 aluminum material, for example, and may include slides along rails to hold the table and provide location assistance.

The gantry 108 may move the spindles 102 across the ice ingots and may move according to instructions to etch patterns into one or more surfaces of each ice ingot. The gantry 108 may use a control system that is based on centerline reference points to allow for a consistent image within the ice blocks that eventually are sliced from the ingot. A computer program can indicate instructions for the gantry to fit multiple images along each ingot based on a size of the cubes being etched. Custom post-processing algorithms can take standard G-code from CAM software, for example, and apply machine-specific information. This includes custom G-code for tool changing, spindle start/stop, and removal of generic G-code that is not utilized in the etching processes.

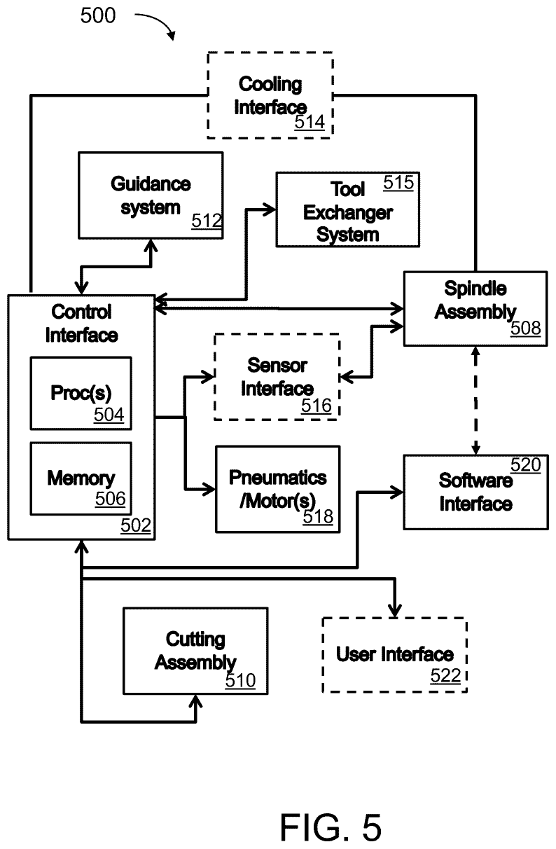

In some embodiments, the ice etching system 100 may be communicatively coupled to or have access to a software interface (e.g., software interface 520 in FIG. 5) in communication with the at least one controller of device 100. The software interface may enable tool selection, spindle warmup control, tool loading, and tool unloading, just to name a few examples. The at least one controller may be part of a control interface 502 (FIG. 5). The control interface 502 may include a CNC system, a spindle guidance system in electrical communication with one or more controllers 504. The control interface 502 may execute software and software interfaces associated with tool selection, spindle warmup, tool loading, and tool unloading.

The ice etching system 100 may further include an ice cutting system having at least one saw assembly to perform ice cuts to shear the at least one ice ingot into multiple ice structures during or after an etching process. The cuts may be predetermined to occur between etched portions of the at least one ice ingot to divide ice blocks that are each etched according to a particular programmed pattern.

In some embodiments, an outfeed assembly may be spaced between a distal end of the table frame 104 and a proximal end of the ice cutting system. The outfeed assembly may include a drive means to guide movement of the at least one ice ingot from the ice etching system 100 to the ice cutting system and to pass the at least one ice ingot through the at least one saw assembly.

FIG. 2B illustrates an example perspective view of the ice etching system 100 of FIG. 2A. As shown, the multi-spindle assembly 102 includes multiple spindles 102a, 102b, etc. In this example, nine spindles 102a, 102b, etc. are shown, but any number of spindles may be coupled to gantry 108 for use in etching any number of ice ingots 120. The spindles 102a, 102b, etc. may be mounted on a custom bracket 122 (e.g., bracket 122a on spindle 102a, bracket 122 in FIG. 2G). The bracket 122a may be attached to the gantry 108 through a framing member 124. For example, each bracket 122 on each spindle in assembly 102 may be coupled to the framing member 124 on a proximal side and a distal side of the framing member 124 may be coupled to the gantry 108. Each bracket 122 may be coupled to the framing member 124 in substantially equal intervals along a length of the framing member 124. In some embodiments, the ice etching system 100 may function as a computer numerical control (CNC) machine mounted to the table frame 104 and the gantry 108. Each of the spindles in spindle assembly 102 may be coupled to at least one rotating shaft (beneath each spindle and coupled to a tool). The rotating shaft may be in electrical communication with the gantry 108.

The spacing between the spindles of assembly 102 may be selected to align with a portion of each of the respective ice ingots below them, ensuring that the spindles hover over a centerline of the respective ice ingot, for example. This allows for consistent image placement even if there are deviations in the thickness of the ice ingots 120. Each of the spindles may be adapted to automatically exchange cutting tools from a first tool set to a second tool set, according to the instructions indicated by one or more recipes or programs described elsewhere herein. Each spindle may include a tool holder for receiving the at least one cutting tool 112. The tool holder includes pneumatic, automated controls for clamping and unclamping of the at least one cutting tool when receiving a command according to the instructions, to exchange the first tool set with the second tool set.

The tool exchanger system described herein (e.g., tool exchanger system 515) may interface with the multi-spindle assembly 102 may include spindles with integrated automatic tool-changing (ATC) ability and custom tool holders to handle tool changes on each spindle. Each ATC may include a pneumatic control for clamping and unclamping the tools. The system 100 may use G-code programming to initiate a tool change and select the tool indicated in a recipe program or programmed instructions. The system may further include an interchangeable tray system for providing the ice ingots on the table frame 104 in a configuration for receiving, according to the instructions, the one or more cutting paths or the one or more etching paths on the ingots.

In some embodiments, spindle speeds may range between 10,000 and 24,000 RPM, with feed rates between about 76 centimeters and about 254 centimeters (between about 30 inches and about 100 inches) per minute. Single and double flute downcut flat end mill bits with cutting lengths between about 0.6 centimeters (about 0.25 inches) and about 1.3 centimeters (about 0.5 inches) may be used. The system 100 may operate in a cold room at about 15 degrees to about 25 degrees Fahrenheit (about −9 degrees to about −4 degrees Celsius) to ensure no ice melt. Ice ingots may be in the specified temperature range prior to etching to stay solid and to produce snow when etched.

The system 100 may further include a vacuum system that includes one or more vacuums and/or one or more blowers to remove (or move) ice chips and water from an etching field occurring around one or more tools and/or ice ingots during an etching process. The vacuum system may further include at least one air nozzle communicatively coupled to the vacuum and mounted to blow air across the etching field and toward the vacuum.

FIG. 2C illustrates an example end view of the ice etching system of FIG. 2A. The multi-spindle assembly 102 may enhance the efficiency and precision of the etching process performed by device 100. For example, by utilizing multiple spindles in assembly 102 with automatic tool-changing capabilities, the system 100 can perform roughing cuts and fine detail cuts simultaneously, significantly improving the overall etching time. The precise alignment of the spindles with the ice ingots 120, combined with the stability provided by the brackets 122, framing member 124, and table frame 104, ensures consistent and accurate etching results.

FIG. 2D illustrates a top down view of the ice etching system 100 of FIG. 2A. The example tray 110 is arranged to hold 18 ice ingots 120 having a length of about 2 meters (about 80 inches). The system 100 includes a multi-spindle assembly 102 having 9 spindles 102a in this example. The multi-spindle assembly 102 may etch ice ingots according to a predefined pattern or recipe. The multi-spindle assembly 102 may utilize a CNC router configuration with a table frame 104, a support 106, and a gantry 108 (e.g., similar to gantry 25 and/or gantry 450). The gantry 108 may allow movement along the z-axis (i.e., function as a z-motion component) and may receive instructions from a controller programmed to etch the ice ingots held by a tray 110.

The multi-spindle assembly 102 includes multiple spindles 102a, etc., each mounted to a bracket 122a (FIG. 2G). The brackets may be attached to the gantry 108 through a framing member 124. For example, each bracket 122a on each spindle in assembly 102 may be coupled to the framing member 124 on a proximal side and a distal side of the framing member 124 may be coupled to the gantry 108. Each bracket 122 may be coupled to the framing member 124 in substantially equal intervals along a length of the framing member 124. A backstop 220 is shown to ensure that ice ingots 120 to align the lengths of the ingots for enabling locational accuracy with respect to an end portion of each ice ingot.

FIG. 2E illustrates a perspective view of an example multi-spindle assembly 102 for use with the devices described herein. In some embodiments, the multi-spindle assembly 102 includes a plurality of spindles 102a, etc. arranged in a linear array configuration along a framing member 124. The framing member 124 extends longitudinally and includes mounting surfaces for securing multiple spindle bracket assemblies (e.g., bracket 122a, etc.). Each spindle (e.g., spindle 102a) in the array may be positioned at predetermined intervals along the framing member 124 to optimize processing efficiency during etching while maintaining structural integrity.

The framing member 124 may include precision-machined mounting surfaces that interface with each bracket assembly 122a. These mounting surfaces may function to maintain alignment tolerances between adjacent spindles in the array. The framing member 124 construction may ensure sufficient rigidity to minimize deflection under operational loads while supporting the weight and dynamic forces of multiple spindles operating simultaneously.

Each spindle (e.g., 102a) in the array may be secured to the framing member 124 through a dedicated respective mounting bracket (e.g., 122a). These brackets, exemplified by bracket 122a, may provide stable mounting points while maintaining precise positional relationships between adjacent spindles. The brackets may be engineered to allow spindle movement while constraining unwanted motion that could affect etching accuracy and/or tool exchange accuracy. Each spindle, such as spindle 102a, includes a tool holding mechanism (e.g., a collar) that secures a cutting tool 112 in precise alignment with the spindle axis.

The multi-spindle assembly 102 may include provisions for routing control cables, pneumatic lines, and other service connections along the framing member 124. These service pathways may be integrated into the assembly design to prevent interference with spindle operation while maintaining accessibility for maintenance operations.

FIG. 2F illustrates a perspective partial view of the multi-spindle assembly of FIG. 2E. The assembly 102 is shown in an etching process being performed on every other ice ingot 120a, 120c, 120e, 120g, 120i, 120k, 120m, 120o, and 120q. Ice ingots 120b, 120d, 120f, 120h, 120j, 120l, 120n, and 120p are awaiting processing upon completion of the spindle assembly 102 etching on the ice ingots 120a, 120c, 120e, 120g, 120i, 120k, 120m, 120o, and 120q.

FIG. 2G illustrates a perspective view of a bracket 122 (e.g., bracket 122a of FIG. 2E) for coupling a spindle to the multi-spindle assemblies described herein. The overall bracket geometry may be designed to optimize structural stability while minimizing weight, thereby enhancing dynamic performance of the gantry system during ice etching operations. In some embodiments, the mounting bracket assembly may include a main structural body 122 formed from a rigid material suitable for precision mechanical applications in food grade environments. The bracket body 122a includes a base plate portion 240 (and a base plate portion 241) with mounting apertures 242, 244, 246, 248 disposed in a predetermined pattern to facilitate secure attachment to a framing member (e.g., framing member 124). These mounting apertures 242, 244, 246, 248 may be precision-machined to maintain precise positioning tolerances when coupled to the framing member.

The bracket assembly may include opposing sidewall portions 250 and 252 extending substantially perpendicular from the base plate portion 240 and 241, respectively. The sidewall portions 250, 252 may at least partially encompass a spindle assembly 102a, for example, to, provide structural support and attachment to a framing member 124 while allowing operational movement. Each sidewall portion 250, 252 may include reinforcing features such as one or more curved transitions between the respective base plate 240, 241 and the sidewall surfaces of portions 250, 252, respectively. Such features may function to enhance structural rigidity while minimizing stress concentration points.

In some embodiments, the sidewall portions 250, 252 may include precisely positioned mounting points for coupling the bracket assembly to a gantry 108, for example. In some embodiments, the sidewall portions 250, 252 may include precisely positioned mounting points for coupling the bracket to the framing member 124, which then mounts to the gantry 108. Example mounting points may include machined surfaces or bushings to ensure proper alignment with corresponding framing member and/or gantry components. The spacing and positioning of these mounting points may be selected to maintain proper spindle orientation during etching and tool exchanging operations while accommodating operational loads and vibrations.

The bracket assembly may include additional mounting apertures or the like positioned on the sidewall portions 250, 252 or back plate 260, as shown by apertures 262, 264, 266, 268, 270, and 272. Such apertures may enable the attachment of auxiliary components such as position sensors, cable management devices, or protective shields. One or more of the auxiliary mounting points 262-272 may be positioned to avoid interference with spindle operation while maintaining accessibility for installation and maintenance operations.

In some embodiments, the body 122 includes precision-machined surfaces where the spindle assembly interfaces with the bracket, ensuring proper alignment and minimal runout during operation. These interface surfaces may include specialized coatings or treatments to enhance wear resistance and maintain positioning accuracy over extended operational periods.

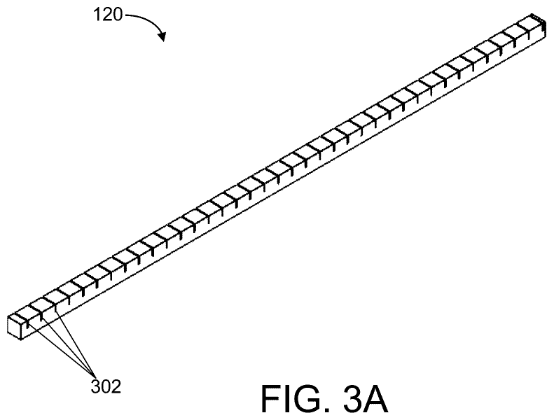

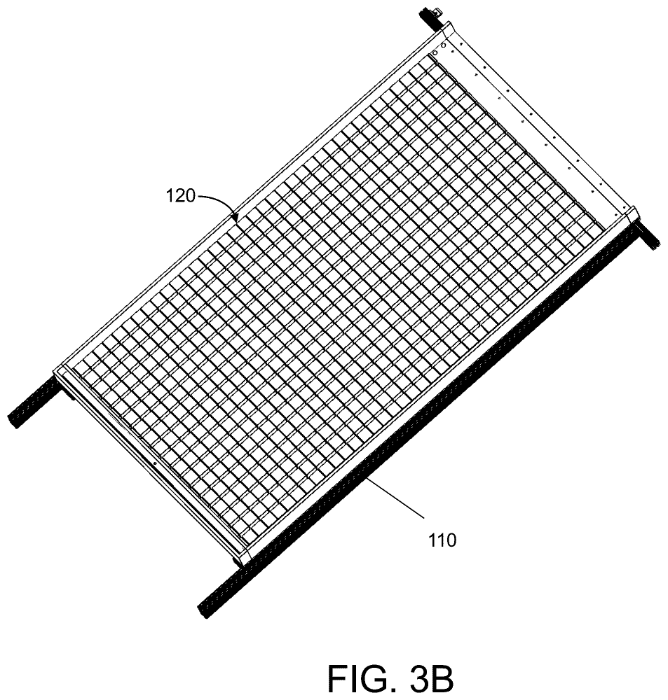

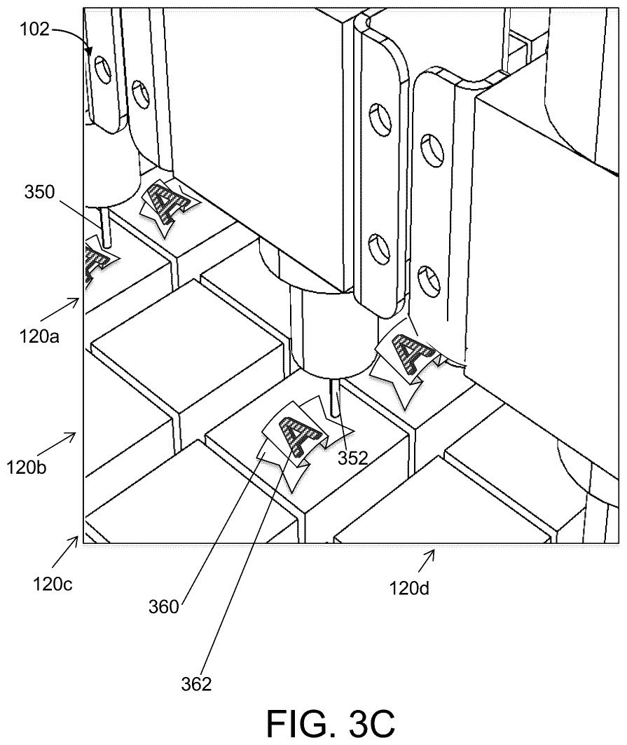

FIG. 3A illustrates a perspective view of an elongate ice ingot 120 for use with the systems described herein. In some embodiments, the ice ingot 120 represents a slab of ice. In some embodiments, the ice ingot 120 represents an ingot of clear ice formed in a flume, mold, or other partially or fully contained apparatus. In some embodiments, the ice ingot 120 may be partially scored or cut, as shown by scores 302, etc. In some embodiments, the ice ingot 120 may not be scored, but may be pre-preprocessed before etching by cutting or planing one or more surfaces of the ice (e.g., one or more of a top surface, a bottom surface, side surface, and/or end surface). In this example, the ice ingot 120 is elongated in shape and may be arranged substantially in parallel to one or more additional and similarly formed ice ingots, each of which may be substantially perpendicular to the plurality of spindles of assembly 102 when presented at system 100 to begin an etching process.

FIG. 3B illustrates a perspective view of an example of a plurality of ice ingots on a tray 110 (e.g., deck) for use with the systems described herein. In some embodiments, up to 18 ice ingots may be placed into the ingot holders (e.g., flexure bars) on the tray 110. In some embodiments, the tray 110 may have integrated guides, end stops, and centering features to ensure correct positioning of ice during etching and/or cutting processes. Operators may use software to create G-code programs for generating the etching patterns to be etched onto each ice ingot 120. The system 100 may interpret such programs to control the spindles of assembly 102 and perform the etching processes described herein. In some embodiments, the spindles of assembly 102 (FIG. 2E) may move in unison to etch the same pattern on one or more of the ice ingots simultaneously or serially. In some embodiments, the spindles of assembly 102 may etch different patterns on one or more of the ice ingots, simultaneously or serially. In some embodiments, the spindles may move in unison to etch the same pattern on a first set of ingots and then may move to a second set of ingots upon completing etching processes on the first set of ingots. In some embodiments, the recipes and/or programming described herein may allow for each set of ingots (or portions of one or more ingots) to be etched with a different pattern.

FIG. 3C illustrates a zoomed in partial view of the ice etching system of FIG. 2A showing etched ice ingots. In the depicted example, elongate ice ingots 120a, 120b, 129c, and 120d are arranged under the spindles (e.g., spindle 350, spindle 352) of assembly 102. The ice ingots 120a and 120c are in the process of being etched by respective spindles 350 and 352. Ice ingots 120b and 120d are not yet etched and assembly 102 may be programmed to etch every other ingot first and then etch the in between ingots upon completion of one or more etching processes on ingots 120a and 120c. In some embodiments, a first set of ingots may be aligned side by side in a substantially parallel arrangement while a second set of ingots may be aligned side by side in a substantially parallel arrangement. The first set may be on a left side of the tray 110 while the second set may be on a right side of tray 110. The spindles may etch the first set and move horizontally to then etch the second set.

An example etching is shown in portions of ice ingots 120a and 120b. The example etching may be indicated by a pattern and/or instructions provided to system 100. The example etching shown here includes a ribbon outline 360 with an emblem 362 centered on a portion of the ribbon outline 360.

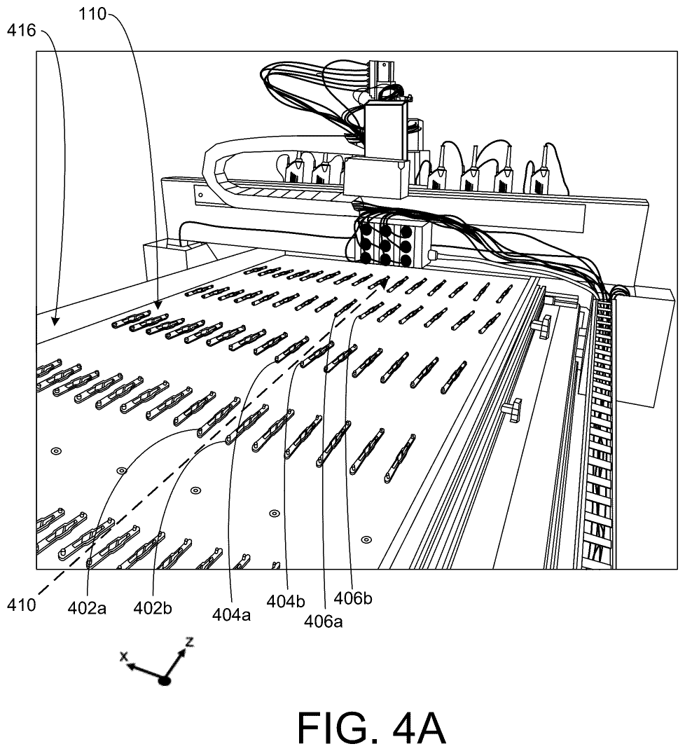

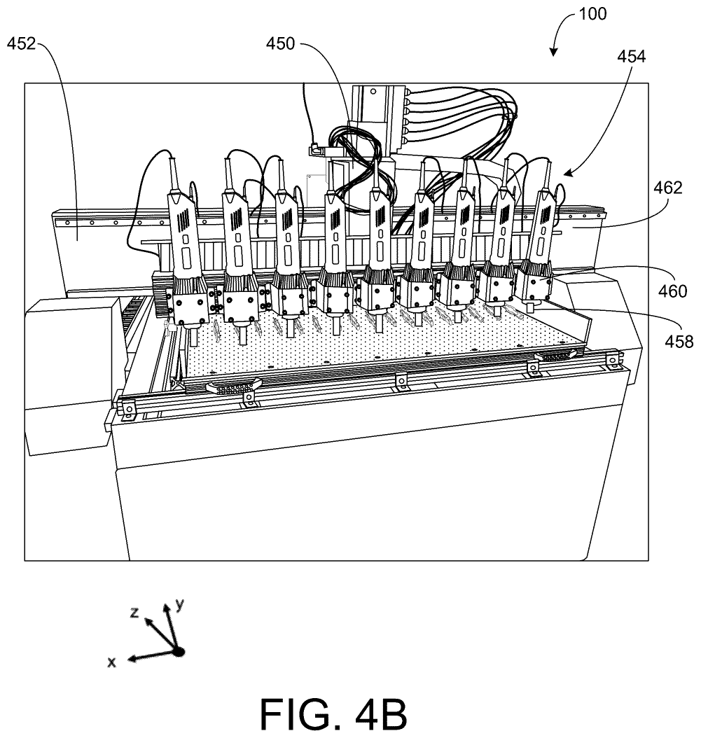

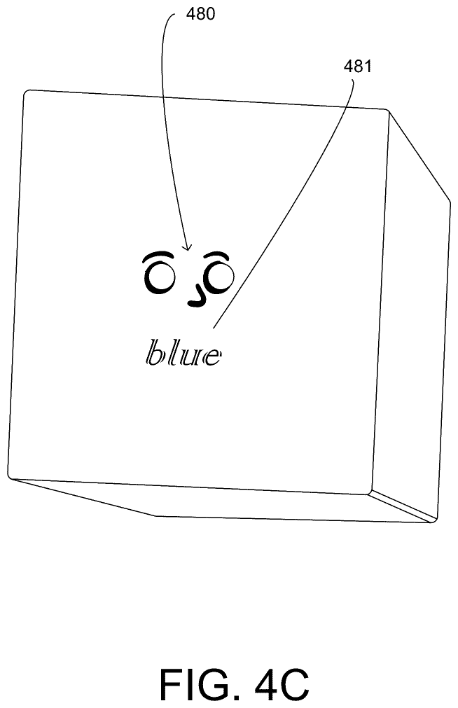

FIG. 4A illustrates a perspective partial view of an example tray for holding a plurality of ice ingots in an example implementation of the ice etching system of FIG. 2A. In some embodiments, the table frame 104 may also include integrated guides, end stops, and centering features. These components may function together to ensure that the ice ingots are correctly positioned on the table frame 104. The guides may help to align the ingots, while the end stops may ensure that they are placed at the correct starting point. The centering features may ensure that the ingots are positioned in the center of the table frame 104 to achieve consistent and accurate etching results.

The tray 110 may be an interchangeable tray system allowing for different ingots of ice to be placed on the table frame 104. The support structure of table frame 104 may be formed of 80/20 aluminum material, for example, and may include slides along rails to hold the table and provide location assistance. In some embodiments, the table frame 104 may be coupled to the interchangeable tray system 416 for positioning ice ingots. The tray system 416 may be equipped with one or more flexure bars (e.g., flexure bars 402a, 402b, 404a, 404b, 406a, 406b, etc.) for securing ice ingots. The flexure bars may function to auto-clamp against the ice ingots 120 and/or may center each ingot simultaneously. For example, the flexure bars 40a-40e may include pairs of components coupled to various portions of the tray 110 and arranged to respectively contact each ingot on portions of both sidewalls to secure the ingots laterally (e.g., x-axis) along the tray 110 during etching. In some embodiments, these flexure bars may avoid clogging due to ice or water accumulation, relying on the flex modulus of the material itself to maintain functionality.

In general, the flexure bars (e.g., 402a, 402b, 404a, 404b, 406a, 406b, etc.) may be coupled to the tray 110. For example, the flexure bars 402a and 402b are coupled to tray 110 and may be substantially in parallel along the z-axis; flexure bars 404a and 404b are coupled to the tray 110 and are substantially in parallel with one another and align, respectively, in the z-axis with flexure bars 402a and 402b; flexure bars 406a and 406b are coupled to the tray 110 and are substantially in parallel with one another and align, respectively, in the z-axis with flexure bars 404a and 404b and respective flexure bars 402a and 402b. Each of the flexure bars 402a, etc. are aligned to accommodate an elongate ice ingot 120 received in a lane defined by the flexure bars 402a and 402b, etc., as shown by arrow 410. Similarly, additional pairs of flexure bars are coupled along the tray 110 longitudinally along the z-axis to form any number of lanes to accommodate elongate ice ingots 120. Multiple pairs of flexure bars are shown in this example spaced across the table width (in the x-axis) according to a predetermined ice ingot width. For example, the multiple pairs of flexure bars are spaced based on a size of ice ingot such that the pairs flexibly hold the ice ingot to allow the ice ingot to slide along the z-axis (e.g., in the lanes formed by additional longitudinally placed pairs of flexure bars) while flexibly stabilizing the ice ingots along the x-axis. This arrangement forms linear lanes for holding and tensioning elongate ice ingots. The pairs of flexure bars may function together in that a spring tension force of each flexure bar provides gentle but consistent pressure to secure the ice ingots during processing (e.g., cutting, etching, etc.).

The flexure bars 402a, etc. may be formed with one or more welded or machined standoff mounts that may be welded, bolted, or otherwise coupled to the tray 110. In some embodiments, the standoff mounts may be molded components that may be welded, bolted, or otherwise coupled to the tray 110. In some embodiments, the flexure bars 402a are coupled by fasteners placed in drilled holes in the tray 110. Gaskets or bushings may also be utilized to provide vibrational isolation during etching or cutting processes. Such gaskets or bushings may also enable component cleanability after completion of etching or cutting processes.

The flexure bars 402a, etc. may further provide ice ingot stabilization by providing consistent spring loaded pressure to hold ice ingots without fracturing such ingots. The spring tension may compensate for variations in ice dimensions while maintaining secure positioning during precise pattern etching occurring across the ice ingot surface(s).

In some embodiments, the flexure bars 402a, etc. may be integrated with the control interface (e.g., control interface 502) of the etching device 100. For example, locations of each flexure bar may be programmed into system 100 as fixed reference points for tool positioning and operation. In some embodiments, position encoders (not shown) may be incorporated into system 100 to track ice movement during etching or cutting processes. In addition, the positioning of flexure bars 402a, etc. may be used as a basis to enable consistent tool depth control of etching or cutting processes. In some embodiments, one or more sensors (e.g., associated with sensor interface 516) may also provide locational data and/or ice positional data to verify ice placement before, during, and after etching or cutting processes.

FIG. 4B illustrates an example of a gantry 450 coupled to a plurality of spindles in an example implementation of the ice etching system of FIG. 2A. In some embodiments, gantry 450 may be represented as shown by gantry 25 or gantry 108. The gantry 450 may be moveably coupled to a fixed support member 452 to allow the gantry 450 to move along a z-axis to align and/or otherwise arrange a number of spindles to perform cutting and/or etching operations. The gantry 450 may allow movement along the z-axis (i.e., function as a z-motion component) and may receive instructions from a controller programmed to etch the ice ingots held by a tray 110 (e.g., a deck, one or more ice holders, and/or an ice retaining system, or the like).

In some embodiments, a multi-spindle assembly 454 includes a plurality of spindles arranged substantially in parallel and movable according to at least two coordinates (e.g., x-axis and z-axis movement). In some embodiments, the plurality of spindles may also be moved in the y-axis to move further into a surface of the ice ingot. Such movements may be performed through controls (e.g., control interface 502) that instruct the gantry 450 and/or through use of movement of ice ingots on the tray 110 along the z-axis. Each spindle may be coupled to at least one cutting tool (e.g., cutting tool 112). The gantry 450 may include a spindle guidance system (e.g., guidance system 512) that is in electrical communication with at least one controller and the plurality of spindles (e.g., spindle 102a, 102b, etc.). The spindle guidance system 512 may be adapted to receive instructions that include one or more patterns and a configuration for the at least one cutting tool 112. The spindle guidance system 512 may use the instructions to control each spindle in the multi-spindle assembly 454 to generate, according to the one or more patterns, one or more cutting paths and/or one or more etching paths on a portion of each of any number of ice ingots on the tray 110.

Each of the spindles shown in FIG. 4B (e.g., spindle 458, etc.) are secured by a bracket 460 that couples to a gantry 450 of the ice etching system through a framing member 462. Each bracket may be coupled to the framing member in substantially equal intervals along a length of the framing member.

The gantry 450 may move the spindles 112 across the ice ingots and may move according to instructions to etch patterns into one or more surfaces of each ice ingot. In some embodiments, the gantry 450 may use a control system that is based on centerline reference points to allow for a consistent image within the ice blocks that eventually are sliced from the ingot. A computer program can indicate instructions for the gantry to fit multiple images along each ingot based on a size of the cubes being etched. Custom post-processing algorithms can take standard G-code from CAM software, for example, and apply machine-specific information. This includes custom G-code for tool changing, spindle start/stop, and removal of generic G-code that is not utilized in the etching processes. In some embodiments, the ice etching system 100 may be a computer numerical control (CNC) machine mounted to a table frame (e.g., frame 104) and the gantry 450. In such an example, each of the spindles may be coupled to at least one rotating shaft (beneath each spindle and attachable to a tool). The rotating shaft may be in electrical communication with the gantry 450.

FIG. 4C illustrates an etched block of ice. In this example, the etching system 100, for example, may have performed process 600 described below to generate an etched pattern 480 and/or text patterns 481 on an ice ingot. In this example, the ice ingot 120 has been further processed and cut into at least one cube. In general, each cube indicates the etched patterns 480, 481. However, the system 100 may be programmed to etch any number of different patterns over the length of an elongate ice ingot. The example etched pattern 480 indicates an etched version of eyes, eyebrows, and a nose of a character and etched pattern 481 includes the word “blue” etched into a surface of the ice. Other example patterns are of course possible.

FIG. 5 illustrates a block diagram of an example ice etching device 500. The device 500 may represent the etcher system 100, which may etch patterns into multiple elongate ice ingots simultaneously. The device 500 may include a control interface 502 having one or more processors 504 and memory 506. The device 500 further includes a spindle assembly 508, a cutting assembly 510, and a guidance system 512. The device 500 further includes an optional cooling interface 514, an optional sensor interface 516, a pneumatics interface/motor 518 and a software interface 520. The device 500 may also include an optional user interface 522.

The device 500 may be programmed to feed an ice ingot through any number of cutting/planing assemblies and/or transport the cut/planed ice to an output location. During etching and/or cutting of the ice ingot, ice pieces and shavings produced by the cutting process may be removed from the cutting field via both a mechanical mechanism (pushing or sweeping) and a vacuuming mechanism. The expelled ice pieces and shavings may be swept or vacuumed into a collection container (not shown. Additionally, or alternatively, ice pieces and shavings may be removed with compressed air streams and/or otherwise melted with an electric heating device. Removing ice pieces and shavings from the cutting field can provide an advantage of maintaining an unmarred (e.g., undamaged, unblemished, etc.) ice surface. For example, ice pieces and shavings that are not removed from the cutting field may cause ice to re-adhere to ice surfaces.

The device 500 may also include a tool exchanger system 515. The tool exchanger system 515 may operate according to one or more algorithms to ensure a coordinated sequence of movements to maximize efficiency and minimize downtime during etching processes. The algorithms may be carried out by one or more processors (e.g., processor(s) 504).

In some embodiments, the tool exchanger system may include a tool storage system in the form of a rotating carousel or linear rack holding multiple tool bits (e.g., tool 112, etc.). The tool storage system may be positioned near the spindles to enable rapid tool changes. Each tool bit may be precisely indexed and secured in a designated slot in the tool storage system, with tools arranged based on anticipated usage frequency and machining requirements. In some embodiments, tools may be arranged according to a preselected pattern to be etched using the ice etching system 100.

In some embodiments, the tool exchanger system 515 may include a tool storage system in the form of a rotating carousel or linear rack holding multiple tool bits. The tool storage system may be positioned near the spindles to enable rapid tool changes. Each tool bit may be precisely indexed and secured in a designated slot in the tool storage system, with tools arranged based on anticipated usage frequency and machining requirements. In some embodiments, tools 112 may be arranged according to a preselected pattern to be etched using the ice etching system 100.

In operation, the tool exchanger system 515 may receive instructions indicated in an etching algorithm, for example (and from one or more processors) to identify and select a tool from the tool storage system. The selection of the tool may trigger the tool magazine to rotate or index to a position in which the selected tool(s) can be physically removed and placed (e.g., installed) into a respective one or more spindles/spindle collars, for example. In some embodiments, a tool in any of the one or more spindles/spindle collars may be removed before selecting and placing (e.g., installing) the selected tool(s). In some embodiments, a robotic arm or motorized gripper may perform tool selection, replacement, and/or installation. The robotic arm or motorized gripper may be part of the system 100 or the tool storage system. In some embodiments, the tool storage system may also include a tool measurement component (e.g., laser or contact-based measurement systems) to verify particular tool installation, geometries, lengths, diameters, or the like.

In some embodiments, the tool exchanger system 515 may operate using one or more tool loading algorithms in combination with one or more tool unloading algorithms. One example algorithm may include a set of instructions that enable selection of one or more tools for installation onto one or more spindles of assembly 102. The algorithm may indicate load times and unload times for particular tools, swapping of tools timing, as well as programmatic timing for performing etchings or cuttings on the ice ingot(s). In general, tools may be selected based on programmatically inputted patterns and/or etching instructions to ensure that an etching pattern is executed on each of the ice ingots according to the programmatic timing.

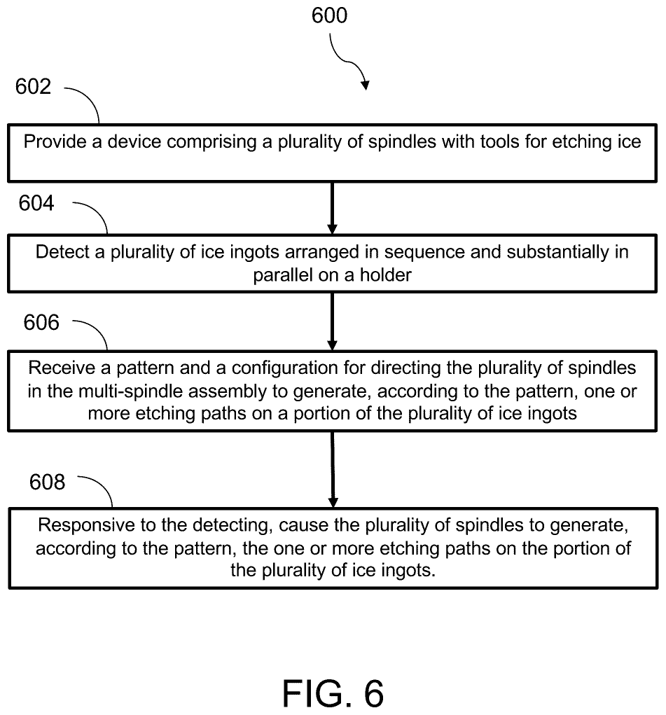

FIG. 6 illustrates a flow diagram of an example process 600 for etching ice. At a high level, process 600 represents a process for manufacturing craft ice that includes using an ice etching device 100. This device includes a table frame (e.g., table frame 104) and a multi-spindle assembly. The multi-spindle assembly 102 may include several spindles that are arranged substantially in parallel in a row and can move according to at least two coordinates and may further move in a third coordinate to etch beyond a surface of the ice ingot(s). Each spindle may be connected to at least one cutting tool. Additionally, a spindle guidance system may be in electrical communication with at least one controller and the multiple spindles. This guidance system may receive instructions for cutting and/or etching ice.

The process may begin by receiving and/or otherwise detecting (by the controller) a series of ice ingots that are arranged in sequence and substantially parallel on a holder (e.g., a tray, a table top, etc.). Instructions are then received, which include a pattern and a configuration. These instructions may be used to direct the multiple spindles in the multi-spindle assembly to create one or more etching paths on a portion of the ice ingots, following the specified pattern. Finally, the spindles are activated to generate the etching paths on the ice ingots according to the given pattern.

At block 602, the process 600 may include detecting a plurality of ice ingots at a holder (e.g., tray 110). For example, the process 600 may detect the ice ingots are arranged in a particular sequence, number, length, weight, or any combination thereof. The holder may be at least partially coupled to the table frame 104. In some embodiments, the ice ingots may be arranged in a predetermined sequence and may be substantially in parallel with each other ice ingot on the holder. For example, a number (e.g., 2-10, 10-14, 14-16, 16-20, 20-24, etc.) of ice ingots 120 may be arranged substantially in parallel on the tray 110. A number of flexure bars 402a, 402b, etc., may hold the arranged ice ingots, as described elsewhere herein. The tray 110 may be provided to or otherwise installed or coupled to device 100.

At block 604, the process 600 may include receiving a pattern and a configuration for directing the plurality of spindles in the multi-spindle assembly to generate, according to the pattern, one or more etching paths on a portion of the plurality of ice ingots. For example, the pattern may indicate instructions for generating an etching or cuts onto one or more surfaces of the ice ingot carried out by at least one of the spindles in the multi-spindle assembly 102.

In some embodiments, the instructions may include a recipe. For example, the controller (e.g., control interface 502) may receive a recipe program defining at least one etching step and at least one post processing step. In such an example, executing the recipe program may cause the system 100 to generate the pattern in the plurality of ice ingots according to the recipe program. One example post processing step may include removing the ice ingots from the tray 110, for example, and transporting the ingots to a cutting assembly to be cut into individual pieces, each having an etched portion. Another example post processing step may include melting the ice ingot to another ice ingot to encase the etched portions between the two ingots. In some embodiments, the cutting of the ice ingots into pieces may be performed after the melting step as an additional post processing step.

At block 606, the process 600 may include responsive to the detecting of the plurality of ice ingots at the holder, causing the plurality of spindles to generate, according to the pattern, the one or more etching paths on the portion of the plurality of ice ingots. For example, a first spindle may generate an etching of the pattern (according to the received instructions) onto portions of a first ice ingot while each other spindle, substantially in parallel to the first spindle, generates an etching of substantially the same pattern onto respective portions of the remaining ice ingots at substantially a same location from an initial length for each ice ingot.

In some embodiments, the process 600 may further include causing advancement of the plurality of spindles in tandem where each respective spindle is advanced over (e.g., above and not in contact with) a respective ice ingot to a second portion of the plurality of respective ice ingots. The second portion may be substantially adjacent to the portion that was previously etched on each respective ingot. The process 600 may further include causing the plurality of spindles to generate, according to the pattern, additional etching paths, that substantially match the one or more etching paths (placed on the first portion of each respective ice ingot), but in this step such etching paths may be applied to or on the second portion of each of the plurality of ice ingots. The process 600 may further include causing the plurality of spindles to repeat the pattern of the one or more etching paths on subsequently adjacent portions of the plurality of ice ingots until reaching a distal end of a length of at least one of the plurality of ice ingots. For example, the etching process may be repeated by each spindle along the length of each ice ingot until reaching the distal end of the length of one or more of the substantially parallelly arranged ice ingots.

In some embodiments, causing the plurality of spindles to generate the one or more etching paths may include causing the plurality of spindles to generate, according to the pattern, the one or more etching paths on the portion of a first of every other ice ingot in the sequence. For example, there may be twice as many ice ingots aligned on the table frame 104 (and/or tray 110) as spindles and the etching may be applied by all spindles on a first batch of the ice ingots and then shifted along the x-axis (FIG. 2B, FIG. 2C) to carry out the etching on the remaining batch of ice ingots. In some embodiments, the pattern may indicate to etch on every third ice ingot or every fourth ice ingot, and so on, in the event that fewer spindles are available than are ice ingots at the device 100.

In some embodiments, the process 600 may further include causing advancement of the plurality of spindles in tandem, to a second portion of the first of every other ice ingot in the sequence. The second portion may be substantially adjacent to the initial etched portion. The process 600 may include causing the plurality of spindles to generate, according to the pattern, additional etching paths that substantially match the one or more initial etching paths, on the second portion of the first of every other ice ingot in the sequence. Further, the process 600 may then include causing the plurality of spindles to repeat the pattern of the one or more etching paths on subsequently adjacent portions of the first of every other ice ingot in the sequence until reaching a distal end of a length of the first of every other ice ingot in the sequence. In some embodiments, upon reaching the distal end of the length, the process 600 may include returning to a proximal end of the length of the plurality of ice ingots and causing the plurality of spindles to generate, according to the pattern, the one or more etching paths on a first portion of a second of every other ice ingot in the sequence. The etching of the second of every other ice ingot in the sequence may advance similarly to the first of every other ice ingot. For example, the process 600 may include causing advancement of the plurality of spindles in tandem, to a second portion of the second of every other ice ingot in the sequence. The second portion may be substantially adjacent to the first portion. The process 600 may further include causing the plurality of spindles to generate, according to the pattern, additional etching paths, that substantially match the one or more etching paths, on the second portion of the second of every other ice ingot in the sequence and causing the plurality of spindles to repeat the pattern of the one or more etching paths until reaching a distal end of a length of the second of every other ice ingot in the sequence.

In some embodiments, ice ingots may go through a preparation process before undergoing etching. For example, ice ingots may be pre-cut to be substantially square on a top, bottom, left side, and right side surfaces. In another non-limiting example, the ice ingots may be cured to a temperature range of about 15 degrees to about 25 degrees Fahrenheit (about −9 degrees to about −4 degrees Celsius) before etching.

In some embodiments, up to about 18 ice ingots may be loaded onto the table frame 104 and/or tray 110. In such an example, the spindles may include one half or fewer of the number of ice ingots. Instructions may be programmed into (or otherwise received at) device 100. The instructions may include one or more patterns and one or more configurations for directing the plurality of spindles in the multi-spindle assembly to generate one or more etching paths on at least a portion of the plurality of ice ingot. The spindles may be installed with a respective tool indicated in the instructions to etch the one or more patterns into the ice ingots. The instructions may include indications of which spindles etch which ice ingot; when each ice ingot is to be etched and in parallel with which other ice ingots; depths, widths, patterns, or other elements of the etchings; ingot handling instructions before, during, and after the etching processes; and the like.

In some embodiments, an example ice etching system 100 may include a table frame 104 and a multi-spindle assembly 102. The multi-spindle assembly 102 may include a plurality of spindles arranged substantially in parallel and movable according to three coordinates, with each spindle coupled to at least one cutting tool. The system 100 may include a spindle guidance system in electrical communication with at least one controller and the plurality of spindles. The spindle guidance system is adapted to receive instructions comprising a pattern and a configuration for the cutting tool and uses these instructions to control each spindle in the multi-spindle assembly. This enables the generation of one or more cutting paths or etching paths on a portion of each of a plurality of ice ingots according to the specified pattern.

For example, an automated ice etching system 100 may include a table frame (e.g., table frame 104) serving as a support structure for a tray 110. The table frame 104 may be constructed to maintain dimensional stability under varying thermal conditions encountered during ice processing operations.

In some embodiments, the system 100 includes a multi-spindle assembly 102 mounted to the table frame 104. The assembly may include a plurality of computer-controlled spindles. These spindles may be arranged in a substantially parallel configuration, with precise spacing (between one or more flexure bars) maintained between adjacent spindles to optimize processing efficiency. Each spindle within the assembly may maintain independent movement capabilities along three coordinate axes, specifically the x-axis for lateral movement, the y-axis for longitudinal movement, and the z-axis for vertical positioning and depth control during etching operations. In some examples described herein, the y-axis may represent vertical positioning and the z-axis may represent longitudinal movement.

Each spindle within the multi-spindle assembly 102 may be coupled to at least one cutting tool through a tool holding mechanism. The tool holding mechanism may provide secure retention of the cutting tool while enabling rapid tool changes for different etching operations. The cutting tools may be designed for ice etching applications, incorporating geometry and materials selected to optimize pattern generation while minimizing thermal effects on the ice surface.

A spindle guidance system may be in electrical communication with the spindles to control spindle operations with precision. The spindle guidance system maintains continuous electrical communication with at least one controller, which may include a processor, a microcontroller, a programmable logic controller (PLC) or similar control device, or a combination thereof. The spindle guidance system may simultaneously maintain communication with the spindles through a high-speed data network, enabling real-time coordination of multiple spindle operations.

The spindle guidance system may include software and hardware components adapted to receive and process detailed instruction sets, recipes, commands, and/or user inputs. The instruction sets may include at least pattern data defining desired ice surface etching features and configuration parameters specifying tool paths, cutting speeds, and depth settings for each spindle operation. The system 100 may process these instructions through algorithms that optimize the movement and coordination of each spindle within the multi-spindle assembly 102.

Through precise control of the spindle operations, the system 100 may enable generation of one or more cutting paths or etching paths on designated portions of multiple ice ingots processed simultaneously. The cutting paths may be generated according to the specified pattern data, with the system maintaining precise dimensional control throughout the etching process. The multi-spindle configuration may enable parallel processing of multiple ice ingots, thereby optimizing production efficiency while maintaining consistent pattern quality across all processed surfaces.

An example system 100 may also include a number of spindles adapted to automatically exchange cutting tools from a first tool set to a second tool set according to instructions. Each spindle in the system 100 may include a tool holder for receiving at least one cutting tool, with the tool holder including pneumatic, automated controls for clamping and unclamping the cutting tool upon receiving a command according to the instructions, thereby facilitating the exchange of the first tool set with the second tool set.

In some embodiments, the tool holder of example system 100 may include an integrated pneumatic actuation system that controls the clamping and unclamping operations of the cutting tools. The pneumatic system may operate under automated control, responding to commands generated according to the programmed instructions for tool exchange sequences.

The tool holder mechanism may include a high-precision collet or similar gripping device that maintains consistent tool positioning while enabling rapid release when commanded. The pneumatic control system may include pressure sensors that monitor clamping force to ensure proper tool retention during operation. In some embodiments, the system 100 may further include verification sensors that confirm proper tool seating before allowing etching or cutting operation to commence.

An automated tool exchange sequence may initiate upon receipt of a command signal from the control system. Upon receiving this signal, the pneumatic system may release a currently installed cutting tool from the first tool set through a controlled pressure reduction sequence. The spindle may then index to an appropriate position for accessing the second tool set. The pneumatic system may subsequently actuate to secure the new cutting tool through a measured pressure application sequence, ensuring a predefined clamping force for the specific tool configuration.

In some embodiments, the control system monitors multiple parameters during the tool exchange sequence, including pneumatic pressure levels, tool presence verification, and proper orientation alignment. The system may include safety interlocks that prevent spindle operation until all tool exchange parameters meet predefined safety requirements. The automated tool exchange sequence may include defined acceleration and deceleration profiles for mechanical movements to protect tool and holder components.

The architecture for system 100 may enable coordination of tool exchanges across multiple spindles, allowing synchronized transitions between tool sets when required by the programmed operations. This coordination may optimize production efficiency by minimizing transition times while maintaining precise control over all exchange operations. The control system may maintain a continuous record of tool usage and exchange operations, enabling predictive maintenance scheduling and tool life management.

The components described herein may be formed of food safe materials (e.g., food grade materials) to ensure the ice manufactured and processed may be for human consumption. Some examples of food safe materials used for the construction of device elements described herein may include Polyethylene, Polycarbonate, Polyethylene Terephthalate, Polypropylene, Silicone, Nylon, Acetal, Polyvinyl Chloride, Polyvinylidene Fluoride, Neoprene, Nitrile, Ethylene Propylene Diene Monomer, Aluminum, Copper, Stainless Steel, or the like. In addition, such materials may be coupled or arranged to avoid hidden spaces or gaps that may trap particles or moisture. For example, transitions in materials may be crafted to seal with smooth transitions between components and/or may be crafted to enable full draining of liquids The various freezing operations and/or related methods may be software controlled or implemented such that freezing cycles, flow rates, and the like may be programmed and controlled by software. In some embodiments, the various freezing operations and/or related methods and variations thereof can be embodied and/or implemented at least in part as a machine configured to receive a computer-readable medium storing computer-readable instructions. The instructions are executed by computer-executable components integrated with the system and one or more portions of the processor on a computing device in communication with various components of the device for producing clear ice, such as but not limited to its various valves, intakes, and/or outtakes. The computer-readable medium can be stored on any suitable computer-readable media such as RAMs, ROMs, flash memory, EEPROMs, optical devices (e.g., CD or DVD), hard drives, floppy drives, or any suitable device. The computer-executable component may be a general or application-specific processor, but any suitable dedicated hardware or hardware/firmware combination can alternatively or additionally execute the instructions.

A computer program product can be tangibly embodied in an information carrier. The computer program product may also contain instructions that, when executed, perform one or more methods and/or computer-implemented methods described herein. The information carrier may be a computer- or machine-readable medium, such as memory, or other storage associated with the ice-making devices described herein.

As used in the description and claims, the singular form “a”, “an” and “the” include both singular and plural references unless the context clearly dictates otherwise. For example, the term “trough” may include, and is contemplated to include, a plurality of troughs. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5 percent, 1 percent or 0.1 percent. All numerical ranges provided herein are inclusive of the stated start and end numbers. The term “substantially” indicates mostly (i.e., greater than 50 percent) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An ice etching system comprising:
a multi-spindle assembly comprising:
a plurality of spindles arranged in parallel and movable according to at least two coordinates, wherein each spindle is coupled to at least one cutting tool; and
a spindle guidance system in electrical communication with at least one controller and the plurality of spindles, the spindle guidance system being adapted to receive instructions comprising a pattern and a configuration for the at least one cutting tool, and use the instructions to control each spindle in the multi-spindle assembly to generate, according to the pattern, one or more cutting path or one or more etching path on a portion of each of a plurality of ice ingots arranged substantially in parallel.

2. The ice etching system of claim 1, wherein each of the plurality of spindles is adapted to automatically exchange cutting tools from a first tool set to a second tool set, according to the instructions, and wherein each of the plurality of spindles comprises:
a tool holder for receiving the at least one cutting tool, the tool holder including pneumatic, automated controls for clamping and unclamping of the at least one cutting tool when receiving a command according to the instructions, to exchange the first tool set with the second tool set.

3. The ice etching system of claim 1, wherein each of the plurality of spindles are secured by a bracket that couples to a gantry of the ice etching system through a framing member, each bracket being coupled to the framing member in substantially equal intervals along a length of the framing member.

4. The ice etching system of claim 3, wherein:
the ice etching system is a computer numerical control (CNC) machine mounted to a table frame and the gantry; and
each of the plurality of spindles is coupled to at least one rotating shaft in electrical communication with the gantry.

5. The ice etching system of claim 3, wherein the ice etching system further comprises an interchangeable tray system for providing the plurality of ice ingots on a table frame in a configuration for receiving, according to the instructions, the one or more cutting path or the one or more etching path in a respective of the plurality of ice ingots.

6. The ice etching system of claim 5, wherein the table frame comprises a plurality of pairs of flexure bars configured to contact each ice ingot on a first sidewall and a second sidewall and in various locations along a length of each ice ingot in the plurality of ice ingots.

7. The ice etching system of claim 6, wherein the plurality of pairs of flexure bars comprise clamps to secure the at least one ice ingot laterally during a cutting process or an etching process.

8. The ice etching system of claim 7, wherein the cutting process slices from a top surface to a bottom surface of one or more of the plurality of ice ingots according to the instructions.

9. The ice etching system of claim 8, wherein the etching process defines partial cuts or indentations in a surface portion of one or more of the plurality of ice ingots.

10. The ice etching system of claim 1, wherein the plurality of ice ingots represent a plurality of slabs of ice.

11. The ice etching system of claim 1, wherein each of the plurality of ice ingots comprise an elongate ice ingot having about 0.8 meters to about 2.0 meters in length.

12. The ice etching system of claim 1, wherein the plurality of spindles are each coupled to the at least one tool to substantially simultaneously, according to the instructions, etch the pattern into the plurality of ice ingots.

13. The ice etching system of claim 1, further comprising a vacuum system comprising a vacuum configured to remove ice chips and water from an etching field occurring around each of the at least one tool during an etching process.

14. The ice etching system of claim 13, wherein the vacuum system further comprises at least one air nozzle communicatively coupled to the vacuum and mounted to blow air across the etching field and toward the vacuum.

15. The ice etching system of claim 1, wherein each of the plurality of ice ingots are elongated in shape and are arranged in parallel to one another and substantially perpendicular to the plurality of spindles.

16. The ice etching system of claim 1, further comprising:
a software interface in communication with the at least one controller, the software interface comprising a tool selection control, a spindle warmup control, a tool unloading control, and a tool loading control.

17. The ice etching system of claim 1, wherein the ice etching system further comprises:
an ice cutting system comprising at least one saw assembly configured to perform a plurality of cuts to shear the at least one ice ingot into multiple ice structures during or after an etching process, the cuts being predetermined to occur between etched portions of the at least one ice ingot;
an outfeed assembly spaced between a distal end of the ice etching system and a proximal end of the ice cutting system, wherein the outfeed assembly comprises a drive means to guide movement of the at least one ice ingot from the ice etching system to the ice cutting system and to pass the at least one ice ingot through the at least one saw assembly.

18. A method for manufacturing craft ice comprising:
providing a device for etching ice comprising:
a table frame; and
a multi-spindle assembly comprising:
a plurality of spindles arranged in parallel and movable according to at least two coordinates, wherein each spindle is coupled to at least one cutting tool; and
a spindle guidance system in electrical communication with at least one controller and the plurality of spindles, the at least one controller being configured to receive and execute instructions comprising:
detecting a plurality of ice ingots arranged in a sequence at a holder, the holder being at least partially coupled to the table frame;
receiving a pattern and a configuration for directing the plurality of spindles in the multi-spindle assembly to generate, according to the pattern, one or more etching paths on a portion of the plurality of ice ingots; and
responsive to the detecting, causing the plurality of spindles to generate, according to the pattern, the one or more etching paths on the portion of the plurality of ice ingots.

19. The method of claim 18, wherein the instructions further comprise:
causing advancement of the plurality of spindles in tandem, each respective spindle being advanced to a second portion of each of the plurality of ice ingots, the second portion being adjacent to the portion;
causing the plurality of spindles to generate, according to the pattern, additional etching paths, that substantially match the one or more etching paths, on the second portion of each of the plurality of ice ingots; and
causing the plurality of spindles to repeat the pattern of the one or more etching paths on subsequently adjacent portions of the plurality of ice ingots until reaching a distal end of a length of at least one of the plurality of ice ingots.

20. The method of claim 18, wherein causing the plurality of spindles to generate, according to the pattern, the one or more etching paths comprises:
causing the plurality of spindles to generate, according to the pattern, the one or more etching paths on the portion of a first of every other ice ingot in the sequence.

21. The method of claim 20, wherein the instructions further comprise:
causing advancement of the plurality of spindles in tandem, to a second portion of the first of every other ice ingot in the sequence, the second portion being adjacent to the portion;
causing the plurality of spindles to generate, according to the pattern, additional etching paths, that substantially match the one or more etching paths, on the second portion of the first of every other ice ingot in the sequence; and
causing the plurality of spindles to repeat the pattern of the one or more etching paths on subsequently adjacent portions of the first of every other ice ingot in the sequence until reaching a distal end of a length of the first of every other ice ingot in the sequence.

22. The method of claim 21, wherein the instructions further comprise:
upon reaching the distal end of the length, returning to a proximal end of the length of the plurality of ice ingots and causing the plurality of spindles to generate, according to the pattern, the one or more etching paths on a first portion of a second of every other ice ingot in the sequence.

23. The method of claim 21, wherein the instructions further comprise:
causing advancement of the plurality of spindles in tandem, to a second portion of the second of every other ice ingot in the sequence, the second portion being adjacent to the first portion;
causing the plurality of spindles to generate, according to the pattern, additional etching paths, that substantially match the one or more etching paths, on the second portion of the second of every other ice ingot in the sequence; and
causing the plurality of spindles to repeat the pattern of the one or more etching paths until reaching a distal end of a length of the second of every other ice ingot in the sequence.

24. The method of claim 18, wherein the instructions further comprise:
receiving a recipe program defining at least one etching step and at least one post processing step; and
executing the recipe program to cause the device to generate the pattern in the plurality of ice ingots according to the recipe program.
